(19) United States
(12) Patent Application Publication
(10) Pub. No.: US 2010/0070080 A1
(43) Pub. Date: Mar. 18, 2010

(54) DEVICE FOR FALL PROTECTION OF YAW RATE SENSORS

(76) Inventor: Leopold BEER, Reutlingen (DE)

Correspondence Address: KENYON & KENYON LLP, ONE BROADWAY, NEW YORK, NY, 10004, US

(21) Appl. No.: 12/304,814

(22) PCT Filed: Jul. 11, 2007
(86) PCT No.: PCT/EP07/57090

§ 371 Date: Apr. 29, 2009

(30) Foreign Application Priority Data
Aug. 28, 2006 (DE) 102006040250.2

(51) Int. Cl. G05B 9/02

(52) U.S. Cl. 700/275

(57) ABSTRACT

A device includes a yaw rate sensor and at least one acceleration sensor. The device has a control device with the aid of which the yaw rate sensor is controllable as a function of an acceleration measured by the acceleration sensor.

### FIELD OF THE INVENTION

The present invention is directed to a device having a yaw rate sensor and at least one acceleration sensor.

### BACKGROUND INFORMATION

Micromechanical yaw rate sensors which operate on the basis of the Coriolis effect contain oscillating structures by principle. In fall tests (standard: 1.5 m drop onto a concrete surface) or other unforeseen accelerations, the micromechanical structures may possibly be permanently damaged, for example, due to the rupture of suspension springs or oscillation springs.

### SUMMARY

Example embodiments of the present invention provide a device having a yaw rate sensor and at least one acceleration sensor. The device has a control device with the aid of which the yaw rate sensor is controllable as a function of an acceleration measured by the acceleration sensor. The yaw rate sensor may thus be advantageously protected against damage in the event of a drop or impact or other accelerations which lie outside the allowable operating parameters.

It is advantageous that the yaw rate sensor has an oscillating structure provided with a drive and the drive is controllable with the help of the control device. It is advantageous in particular that the drive may be switched off with the aid of the control device.

An example embodiment of the present invention provides that a lockdown of the movable parts, in particular the oscillating structure of the yaw rate sensor, is operatable with the aid of the control device.

It is advantageous in particular that the device is designed using microsystem technology. It is advantageous that the yaw rate sensor, as well as the acceleration sensor and the control device, is situated on a shared semiconductor substrate.

The device advantageously has a plurality of acceleration sensors, for example, for different measuring ranges or sensing devices for the different spatial directions.

A drop may be advantageously detected by an additional sensor such as, for example, a three-axis acceleration sensor, and measures may be taken in the yaw rate sensor for enhancing sturdiness. Thus, the drive of the oscillating structure, for example, may be switched off, or the oscillator may be electrostatically drawn into a certain position, or the sensor may be locked down.

An exemplary embodiment of the present invention is illustrated in the drawing and explained in greater detail in the description that follows.

### BRIEF DESCRIPTION OF THE DRAWING

FIG. 1 schematically shows a device according to an example embodiment of the present invention having a yaw rate sensor, an acceleration sensor, and a control device.

### DETAILED DESCRIPTION

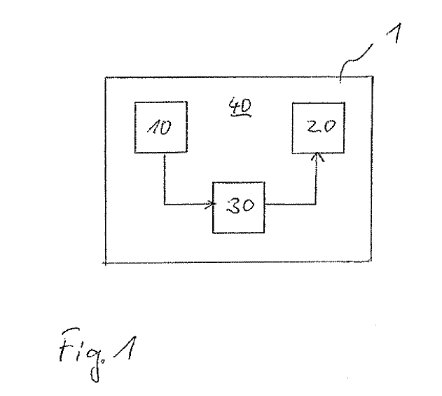

FIG. 1 schematically shows a device according to an example embodiment of the present invention having a yaw rate sensor, an acceleration sensor, and a control device. The drawing shows a device 1 which has an acceleration sensor 10 and a yaw rate sensor. Acceleration sensor 10 is situated in the proximity of yaw rate sensor 20, so that it substantially measures accelerations also acting upon yaw rate sensor 20. A sensor signal of the acceleration sensor is supplied to a control device 30. In control device 30, a control signal is generated from the sensor signal and is supplied to yaw rate sensor 20. Control device 30 may be designed as an electronic circuit. In this schematic illustration, it is proposed as a standalone unit. Control device 30 may, however, also be a component of acceleration sensor 10, for example, a component of its analyzer circuit. Control device 30 may also be a component of yaw rate sensor 20, for example, of its drive circuit. Finally, acceleration sensor 10, yaw rate sensor 20, and control device 30 may also be provided on a shared semiconductor substrate, micromechanical structures being provided for acceleration sensor 10 and yaw rate sensor 20 and, for example, shared electronic circuits, also containing control device 30, being provided on semiconductor substrate 40.

In manufacturing the device according to example embodiments of the present invention, a three-axis acceleration sensor 10 may be produced in the same MEMS manufacturing process as yaw rate sensor 20, and thus be manufactured on a chip 40 or also as a sensor cluster.

1-6. (canceled)

7. A device, comprising:
a yaw rate sensor;
an acceleration sensor; and
a control means device adapted to control the yaw rate sensor as a function of an acceleration measured by the acceleration sensor.

8. The device according to claim 7, wherein the yaw rate sensor includes an oscillating structure provided with a drive, the drive controllable by the control device.

9. The device according to claim 8, wherein the drive is switchable off by the control device.

10. The device according to claim 7, wherein a lockdown of movable parts of the yaw rate sensor is operatable by the control device.

11. The device according to claim 7, wherein the device is arranged as a microsystem device.

12. The device according to claim 7, wherein at least one of (a) the yaw rate sensor, (b) the acceleration sensor, and (c) the control device is arranged on a shared semiconductor substrate.
